(19) United States
(12) Patent Application Publication
(10) Pub. No.: US 2015/0084433 A1
(43) Pub. Date: Mar. 26, 2015

(54) STANDALONE POWER CORD TO AUTOMATE ELECTRICAL APPLIANCES FOR HOME AUTOMATION

(71) Applicant: Linkez Technologies Private Limited, Hubli (IN)

(72) Inventor: Divyesh Kumar Shah, Bangalore (IN)

(73) Assignee: Linkez Technologies Private LimitedHubli, Hubli (IN)

(21) Appl. No.: 14/493,385

(22) Filed: Sep. 23, 2014

(30) Foreign Application Priority Data
Sep. 23, 2013 (IN) 4301/CHE/2013

(51) Int. Cl. H02J 4/00

(52) U.S. Cl. CPC H02J 4/00
USPC 307/112

(57) ABSTRACT

A standalone power cord to control an electrical appliance for home automation includes a first electrical connector at one end of the standalone power cord. The first electrical connector connects the standalone power cord to a power source. The standalone power cord includes a second electrical connector at other end of the standalone power cord. The second electrical connector connects the standalone power cord to an electrical appliance. Further, the standalone power cord includes a smart control module to control the electrical appliance. The smart control module includes a smart link interface compliant-power cable (SLIC-P) and a smart link interface compliant-socket (SLIC-C). The SLIC-P enables switching ON and switching OFF the electrical appliance. The SLIC-C enables the stand alone power cord to fine-control one or more parameters of the electronic appliance.

### CROSS-REFERENCE TO RELATED APPLICATION

This application claims the priority of Indian Provisional Patent Application No. 4301/CHE/2013 filed on Sep. 23, 2013, the disclosure of which is incorporated herein in its entirety.

### FIELD OF THE INVENTION

The present invention relates to the field of home automation and more specifically to a module enabling home automation.

### BACKGROUND

Conventional home automation systems are controlled by equipment's installed at the customer premises. By programming an in-house device, a user controls the operation of appliances connected to a system. There are several disadvantages associated with the conventional home automation systems. For example, in the conventional home automation systems, the appliances are connected to the in-house device via smart switches. In the conventional home automation systems, the smart switches are connected to the in-house device via a wireless network. The use of wireless networks increases the overall cost of the system because each of the smart switches require separate wireless transceivers, wherein the conventional wireless transceivers are expensive. While the conventional home automation systems provide the user with home automation functionality, the high cost of the conventional home automation systems limits wide spread use.

The high cost of the conventional home automation systems are reduced to some extent by replacing the wireless network by a network based on power line communication. However, switches and power sockets in the existing electrical wiring in a building are required to be upgraded prior to the installation of existing power line communication. Upgrading the switches and power sockets depends on type of home automation system present in the building. Moreover, the existing power line communication based home automation systems do not provide any means to control existing appliances unless the existing appliances are sufficiently rigged/altered by an expert to be compliant with the system.

The conventional home automation systems provide a facility for switching ON and switching OFF electrical appliances. However, the conventional home automation systems fail to provide further control of the electrical appliances. If any further control over the appliance has to be implemented, the systems require considerable effort on the part of the appliance manufacturer and the designer to make the appliances compatible with the system. Yet another disadvantage of the current systems is that the current systems fail to provide means to access performance related data from the appliances connected to the system.

In light of the foregoing discussion, there is a need for a new system and method for implementing home automation with improved flexibility in a cost effective manner.

### SUMMARY

The above mentioned needs are met by implementing a module for home automation in a cost effective manner. The system is a standalone power cord with a smart control module. The smart control module controls operation of an electrical appliance. The electrical appliance is controlled by a request initiated by a user. The smart control module enables switching ON and OFF the electrical appliance based on the request. Further, the smart control module fine-controls the functioning of the electronic appliance by regulating the operational parameters.

An example of a standalone power cord to control an electrical appliance includes a first electrical connector at one end of the standalone power cord. The first electrical connector connects the standalone power cord to a power source. The standalone power cord includes a second electrical connector at other end of the standalone power cord. The second electrical connector connects the standalone power cord to the electrical appliance. Further, the standalone power cord includes a smart control module to control the electrical appliance. The smart control module includes a smart link interface compliant-power cable (SLIC-P) module and a smart link interface compliant-socket (SLIC-C) module. The SLIC-P module enables switching ON and switching OFF the electrical appliance. The SLIC-C module enables the standalone power cord to fine-control one or more parameters of the electronic appliance.

An example of a method of controlling an electrical appliance includes receiving a request from a user of the electrical appliance. The request is received by a central unit to control the electrical appliance. The method includes transmitting the request as a signal by the central unit. The signal includes at least one of a data signal and a control signal. Further, the method includes decoding the signal by the standalone power cord. Furthermore the method includes controlling the electrical appliance based on the request. The controlling is performed by the standalone power cord.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF FIGURES

In the following drawings like reference numbers are used to refer to like elements. Although the following figures depict various examples of the invention, the invention is not limited to the examples depicted in the figures.

FIG. 1 is a block diagram of an environment, in accordance with which various embodiments of the invention can be implemented;

FIG. 2A is a schematic diagram of a standalone power cord with a smart control module, in accordance with an embodiment of the present invention;

FIG. 2B depicts front view of an electrical connector of a standalone power cord with the smart control module;

FIG. 2C is a schematic diagram of a standalone power cord with bare wires exposed, in accordance with one embodiment of the present invention;

FIG. 3A is a schematic diagram of a Smart Link Interface Compliant-Power (SLIC-P) module in a smart control module, in accordance with one embodiment of the present invention;

FIG. 3B is a block diagram of a Smart Link Interface Compliant-Socket (SLIC-C) module in a smart control module, in accordance with another embodiment of the present invention;

FIG. 4 is a schematic diagram of a standalone power cord with a SLIC-P module, in accordance with one embodiment of the present invention;

FIG. 5 is a schematic diagram of a smart control module embedded in an electrical appliance, in accordance with another embodiment of the present invention;

FIG. 6 is a schematic diagram of a standalone power cord with a SLIC-C module embedded in the socket, in accordance with yet another embodiment of the present invention;

FIG. 7 is a schematic diagram of a standalone power cord with a SLIC-P and SLIC-C module embedded in electrical connectors, in accordance with yet another embodiment of the present invention;

FIG. 8 is a block diagram of a standalone power cord with a SLIC-P and SLIC-C module embedded in electrical connectors, in accordance with yet another embodiment of the present invention;

FIG. 9 is a flowchart illustrating method of controlling an electrical appliance, in accordance with one embodiment of the invention; and

FIG. 10 is a flowchart illustrating steps to control an electrical appliance, in accordance with another embodiment of the invention.

### DESCRIPTION

Embodiments of the present disclosure described herein disclose a smart device for implementing a home automation system in a building without having the need for upgrading switches and power sockets in an existing electrical wiring of the building. Further, the present invention aids in eliminating the need for using expensive wireless networks to implement the home automation system. The present invention enables the electrical appliances to communicate via electrical wiring by making use of modules in accordance with an embodiment of the present invention. In one embodiment of the present invention, the modules are implemented within a smart detachable power cord of the electrical appliances. The smart detachable power cord includes modules for controlling the electrical appliances. In another embodiment of the present invention, the electrical appliances lack detachable power cords and the modules are integrated within the electrical appliances. The modules disclosed in the present invention are of two types, a Smart Link Interface Compliant-Power (SLIC-P) module and a Smart Link Interface Compliant-Socket (SLIC-C) module.

In the present disclosure, relational terms such as first and second, and the like, may be used to distinguish one entity from the other, without necessarily implying any actual relationship or order between such entities. The following detailed description is intended to provide example implementations to one of ordinary skill in the art, and is not intended to limit the invention to the explicit disclosure, as one or ordinary skill in the art will understand that variations can be substituted that are within the scope of the invention as described.

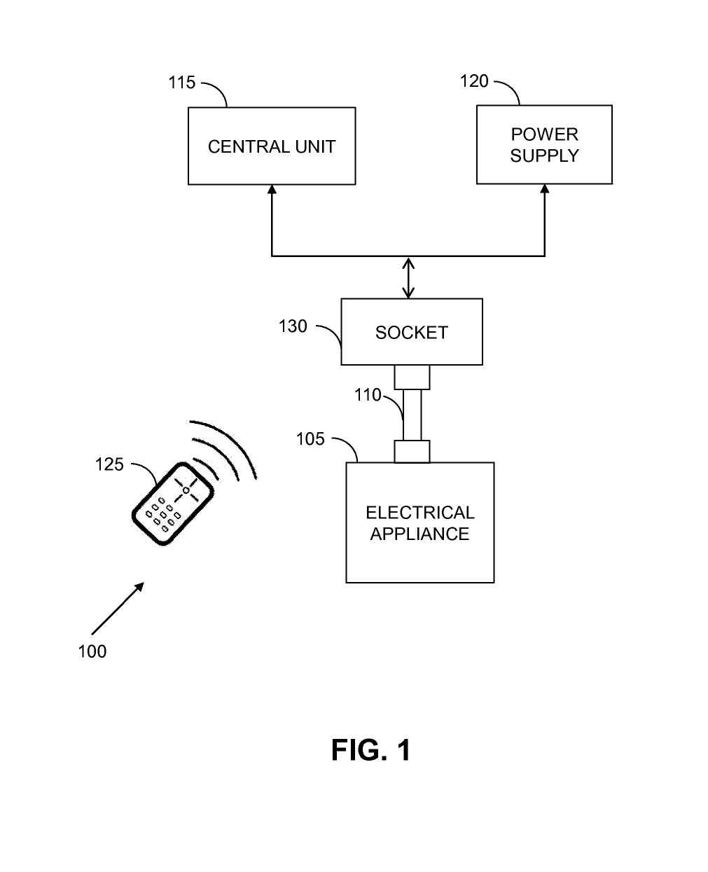

FIG. 1 is a block diagram of an environment 100, in accordance with which various embodiments of the invention can be implemented. The environment 100 includes an electrical appliance 105, a standalone power cord 110, a central unit 115, a power supply 120, a remote control 125 and a socket 130. The electrical appliance 105 is one of a refrigerator, an air conditioner, a television, a water heater, a microwave oven, a coffee maker, a lighting device, and a fan. The electrical appliance 105 is connected to the power supply 120 using the standalone power cord 110. In order to control the electrical appliance 105, a user initiates a request to the central unit 115 via a remote control 125. The request is communicated to the standalone power cord 110 via electrical wiring in the building. The standalone power cord 110 decodes the request to control the electrical appliance 105.

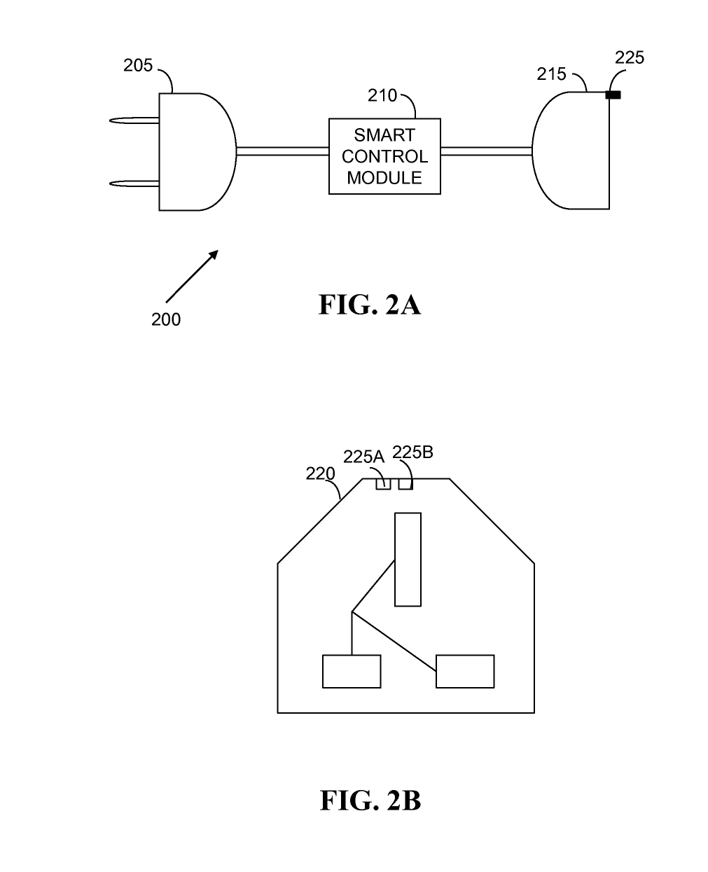

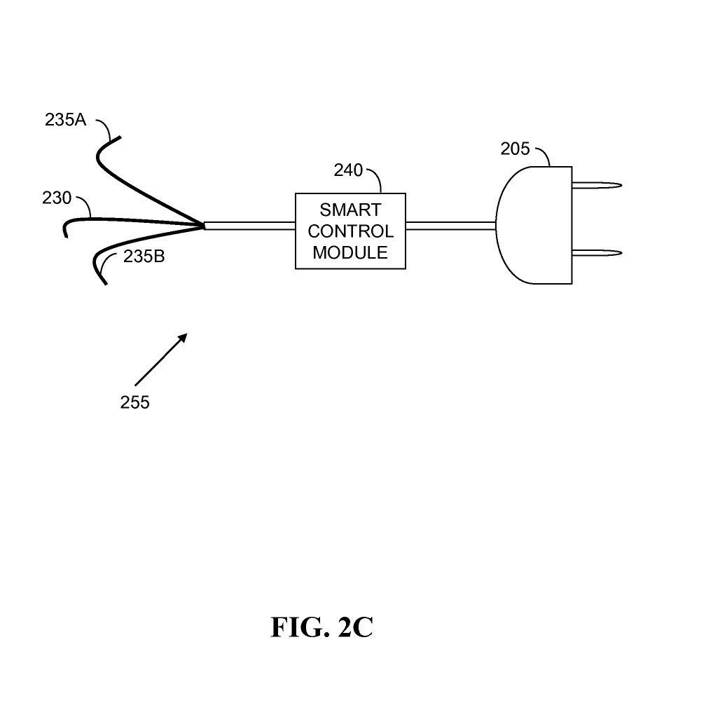

FIG. 2A is a schematic diagram of a standalone power cord 200 to control the electrical appliance, in accordance with the present invention. The standalone power cord 200 is a detachable power cord. The standalone power cord 200 includes a first electrical connector 205, a second electrical connector 215 and a smart control module 210. The first electrical connector 205 is at one end of the standalone power cord 200. The first electrical connector 205 connects the standalone power cord 200 to a power source. Further, the first electrical connector 205 provides electrical connection to the smart control module 210. The smart control module 210 connects the first electrical connector 205 and the second electrical connector 215.

The second electrical connector 215 is at other end of the standalone power cord 200. The second electrical connector 215 connects the standalone power cord to the electrical appliance. The second electrical connector 215 includes a power terminal 220 and a signal terminal. In one embodiment of the invention, the signal terminal functions as a single terminal for data and control instructions. In another embodiment of the invention, the signal terminal functions as two independent terminals, data signal terminal and a control signal terminal. In some embodiments, the signal terminal can include multiple terminals. In another embodiment of the invention, at least one of a Light Emitting Diode and photo transistor pair is used as the signal terminal. The signal terminal is herein referred to as a data and control signal terminal 225. The power terminal 220 supplies power to the electrical appliance. The data and control signal terminal 225 enables communication between a microprocessor in the electrical appliance and the smart control module 210. The microprocessor provides a data interface and a control interface to the smart control module 210. The smart control module 210 communicates with the microprocessor of the electrical appliance following any of the known or proprietary communication protocols including Serial Peripheral Interfaces (SPI), Universal Asynchronous Receiver/Transmitter interfaces (UART) and Inter-Integrated Circuit bus (I2C). In scenarios where electrical isolation is desired, optical transceivers using infrared and visible light or any other wireless means of communication, for example, near field communication (NFC), are used for the communication between the smart control module 210 and the microprocessor of the electrical appliance. It is to be noted that, the second electrical connector 215 can include any signal isolation transceiver.

The smart control module 210 controls the electronic appliance for home automation, based on a request from a user. The request is one of a data request and a control request. The user initiates the request via one of a remote control and a user interface. The request from the user is received by a central unit connected to the power supply. The central unit transmits the request as a signal to the standalone power cord 200. The communication of the signal between the central unit and the smart control module 210 in the standalone power cord follows any of the known or proprietary power line communication protocols including PLC-BUS communication protocol, X-10 protocol, CE Bus protocol, and Home plug 1.0 protocol. In some embodiments, the protocol used can be other than power line protocols, such as zigbee, Wifi, Bluetooth etc. The smart control module 210 in the standalone power cord 200 receives the signal through electrical wiring in the buildings. The smart control module 210 further decodes the request from the signal. The smart control module 210 further includes a Smart Link Interface Compliant-Power cable (SLIC-P) module and Smart Link Interface Compliant-Socket (SLIC-C) module. The SLIC-P module enables switching ON and switching OFF the electrical appliance. The switching ON and switching OFF is performed based on the control request initiated by the user. The SLIC-C module enables fine-control of one or more parameters of the electrical appliance. The parameters include but are not limited to temperature, speed, brightness, and volume. The parameters are controlled based on the data request initiated by the user.

FIG. 2B is a schematic diagram of the front view of the second electrical connector 215 within the standalone power cord 200 depicted in FIG. 2A. The second electrical connector 215 includes the power terminal 220 and the data signal terminal 225A and control signal terminal 225B. The power terminal 220 supplies power to the electrical appliance. The data signal terminal 225A and control signal terminal 225B enables communication between a microprocessor in the electrical appliance and the smart control module 210. The microprocessor provides a data interface and a control interface to the smart control module 210.

FIG. 2C is a schematic diagram of a standalone power cord with bare wires exposed, in accordance with one embodiment of the present invention. It is to be noted that, unlike in FIG. 2A, where the standalone power cord has electrical connectors at either ends, FIG. 2C depicts the standalone power cord having one electrical connector at one end and the other end open. Such a configuration enables the manufacturer of the electrical appliance to easily integrate the power cord to the electrical appliance. An electrical connector includes a power terminal 230, a data signal terminal 235A, and control signal terminal 235B. The power terminal 205 supplies power to the electrical appliance. The data signal terminal 235A and control signal terminal 235B enables communication between the electrical appliance and the smart control module 240. The electrical connector 245 connects the standalone power cord 255 to the electrical mains.

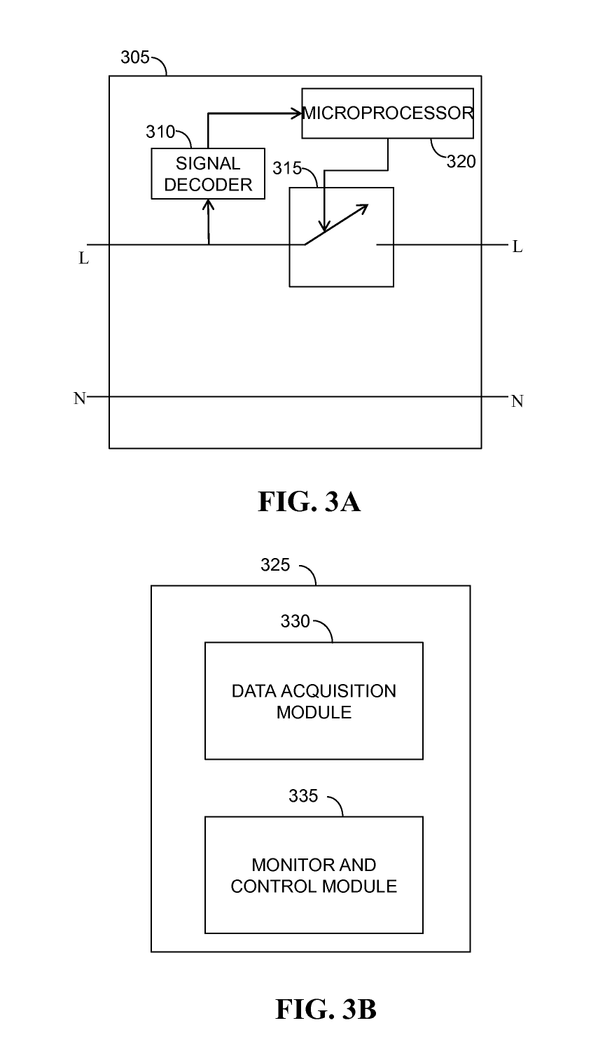

FIG. 3A is a schematic diagram of a SLIC-P module in a smart control module. The SLIC-P module 305 includes a signal decoder 310, a relay switch 315, and a microprocessor 320. The signal decoder 310 is connected to power supply via a standalone power cord. The signal decoder 310 receives a request for controlling an electrical appliance via power lines in a building. When a user initiates the request at a central unit, the request is transmitted to the standalone power cord through the power lines. The communication of the signal between the central unit and the smart control module in the standalone power cord follows any of the known or proprietary power line communication protocols including PLC-BUS communication protocol, X-10 protocol, CE Bus protocol, and Home plug 1.0 protocol. The request is encoded at the central unit and transmitted as signals. The signal decoder 310 decodes data and control instructions from the signals. The decoded data and control instructions are sent to the microprocessor 320.

The microprocessor 320 performs one of switching ON and switching OFF of the relay switch 315 based on the control instruction from the signal decoder 310. The relay switch 315 provides a path for current flow between the first electrical connector and the second electrical connector of the standalone power cord. Therefore, the SLIC-P module 305 enables switching ON and switching OFF of the electrical appliance. In some embodiments, the signal decoder 310 can be replaced with a wireless module that supports any standard or proprietary wireless communication protocol. The proprietary communication protocols including but is not limited to SPI, UART and I2C.

FIG. 3B is a block diagram of a SLIC-C module 325 in a smart control module, in accordance with the present invention. The SLIC-C module 325 includes a data acquisition module 330 and a monitor and control module 335. The data acquisition module 330 acquires data pertaining to the electronic appliance. The data acquisition is performed by a data and control signal terminal on the standalone power cord. The data and control signal terminal enables communication between a microprocessor in the electrical appliance and the smart control module. Further, the monitor and control module 335 monitors the internal settings of the electrical appliance. Furthermore, the monitor and control module 335 controls internal settings to achieve fine-control of the electrical appliance. The fine-control is performed based on the data request decoded by the signal decoder 310 in the SLIC-P module 305 depicted in FIG. 3A. The fine-control is performed by controlling one or more parameters of the electrical appliance such as temperature, speed, brightness, and volume.

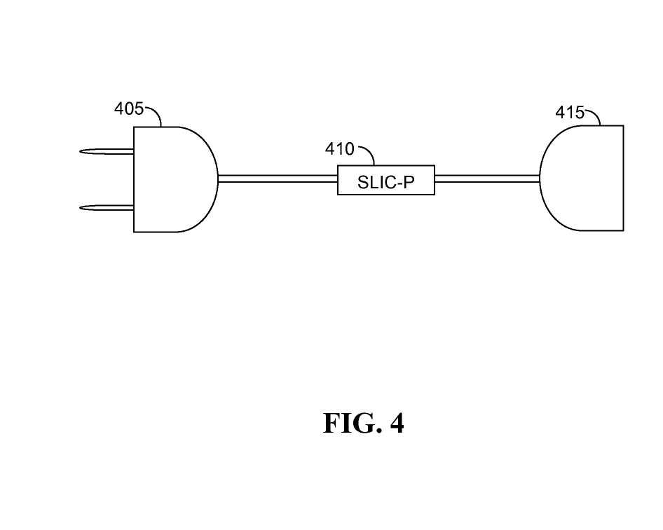

In a first embodiment of the present invention, home automation is performed by a SLIC-P module in a standalone power cord. FIG. 4 is a schematic diagram of a standalone power cord. The standalone power cord includes a first electrical connector 405, a SLIC-P module 410, and a second electrical connector 415. The first electrical connector 405 connects to a power socket in an electrical wiring in the building and provides electrical connection to the SLIC-P module 410. The SLIC-P module 410 connects the first electrical connector 405 and the second electrical connector 415. The second electrical connector 415 provides electrical connection between the SLIC-P module 410 and an electrical appliance. The SLIC-P module 410 performs one of connecting and disconnecting the first electrical connector 405 and the second electrical connector 415 based on a power line communication signal from the power supply. Thus, with the help of SLIC-P module 410, the standalone power cord controls the switching ON and switching OFF of the electrical appliance.

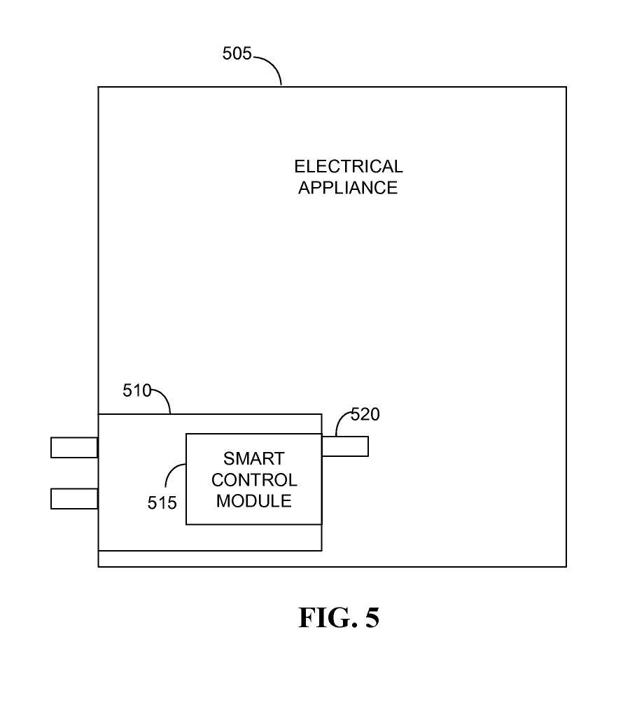

In a second embodiment of the present invention, home automation is performed by a smart control module implemented in an electrical appliance. FIG. 5 is a schematic diagram of the smart control module 515 in an electrical appliance 505. The electrical appliance 505 includes an appliance socket 510. The appliance socket 510 includes the smart control module 515, and a control terminal 520. The smart control module 515 includes an integrated SLIC-P module and a SLIC-C module. The smart control module 515 decodes signals from a central unit and encodes information into the power supply wirings as signals. The smart control module 515 communicates with a microprocessor in the electrical appliance 505. The microprocessor provides a data interface and a control interface to the smart control module 515. The signal terminal 520 is one of a data signal terminal, a control signal terminal or a combination of the data signal terminal and the control signal terminal. The signal terminal 520 communicates with the microprocessor of the electrical appliance 505 following any of the known or proprietary communication protocols including SPI, UART and I2C. In scenarios where electrical isolation is desired, optical transceivers using infrared and visible light or any other means of signal isolation are used for the communication between the smart control module 515 and the microprocessor of the electrical appliance. The smart control module 515 enables monitoring and controlling of internal settings of the electrical appliance 505. Further, the smart control module 515 is enabled to perform one of switching ON and switching OFF of the electrical appliance 505 based on decoded signals from the power supply wirings.

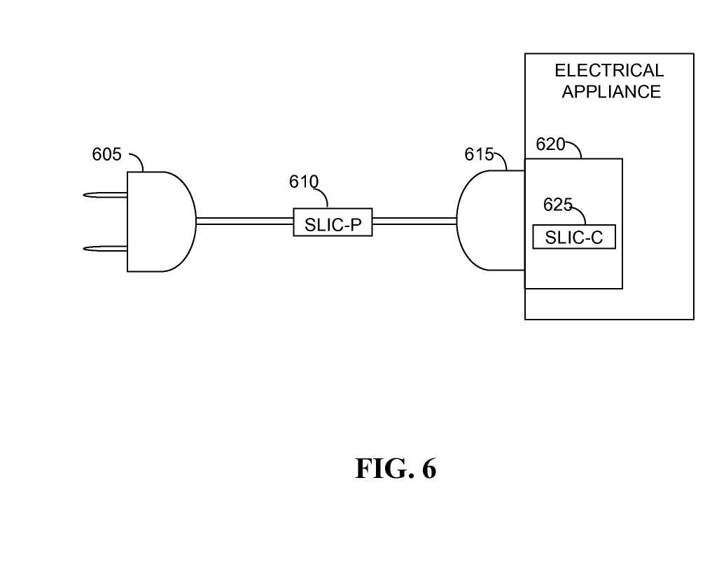

In a third embodiment of the present invention, home automation is performed by a standalone power cord and an electrical appliance. FIG. 6 is a schematic diagram of a SLIC-P module embedded in the standalone power cord and a SLIC module embedded in appliance socket. The power cord includes a first electrical connector 605, a SLIC-P module 610, a second electrical connector 615 and an appliance socket 620. The appliance socket 620 includes the SLIC-C module 625. The SLIC-P module 610 receives a request from a user to control the electrical appliance. The SLIC-P module 610 receives the signals as signal from the electrical wiring in the building. The SLIC-P module 610 decodes the signals. Further, the SLIC-P module 610 enables “switch ON” and “switch OFF” of the electrical appliance.

The SLIC-C module 625 installed in the appliance socket 620 of the electrical appliance provides an exposed interface to the electrical appliance. Examples of the exposed interface include but are not limited to Serial Peripheral Interfaces and Universal Asynchronous Receiver/Transmitter interfaces, optical transceivers, or other means of signal isolation. The exposed interface of the SLIC-C module 625 acquires data pertaining to the electrical appliance. The SLIC-C module 625 is able to transfer data to and from the electrical appliance. Further, the SLIC-C module 625 is enabled to monitor and control internal settings of the electrical appliance.

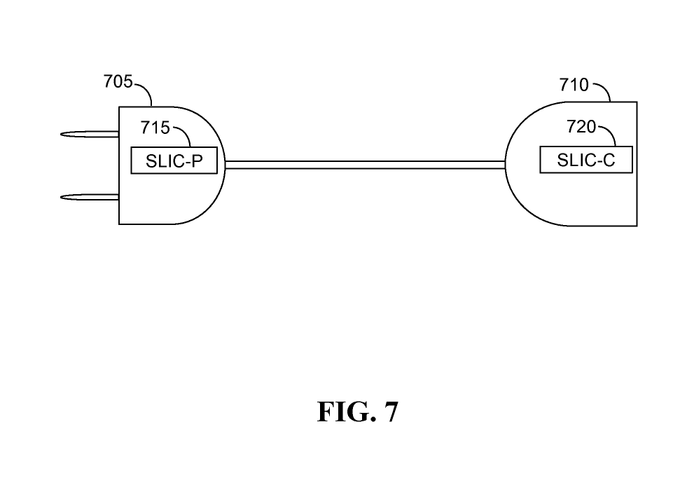

In a fourth embodiment of the present invention, home automation is performed by a SLIC-P module and a SLIC-C module embedded in the electrical connectors of a standalone power cord. FIG. 7 is a schematic diagram of the standalone power cord. The standalone power cord includes a first electrical connector 705 and a second electrical connector 710. The first electrical connector 705 is at one end and the second electrical connector 710 is at the other end of the standalone power cord. The first electrical connector 705 is connected to power socket in the building. The first electrical connector 705 includes a SLIC-P module 715. The SLIC-P module 715 receives signal from the electrical wiring in the building. The SLIC-P module 715 further decodes the signal. Further, the SLIC-P module 715 controls an electrical appliance based on the control signal decoded from the signal.

The second electrical connector 710 is at the other end of the standalone power cord. The second electrical connector 710 is connected to appliance socket of the electrical appliance. The second electrical connector 710 includes a SLIC-C module 720. The SLIC-C module 720 acquire the data pertaining to the electrical appliance. The data is acquired by communicating with a microprocessor in the electrical appliance. Further, the SLIC-C module 720 monitors the internal settings of the electrical appliance. Furthermore, the SLIC-C 720 module fine-control the electrical appliance based on the data signal decoded from the signal by the SLIC-P module 715. The fine-control is performed by regulating the parameters of the electrical appliance such as temperature, speed, brightness, and volume.

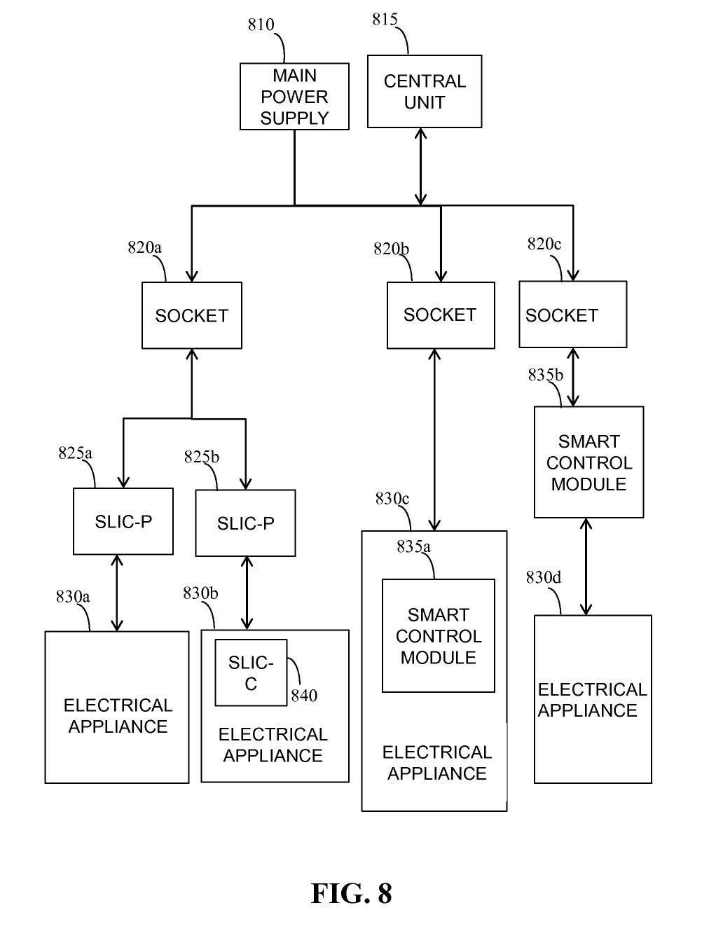

FIG. 8 is a block diagram 800 of a standalone power cord with a SLIC-P and SLIC-C module embedded in electrical connectors. The block diagram 800 includes a plurality of electrical appliances 830a, 830b, 830c, and 830d, a central unit 815, a plurality of sockets 820a, 820b, and 820c, a plurality of SLIC-P modules 825a and 825b, a plurality of smart control modules 835a and 835b, and a main power supply 810. The plurality of electrical appliances 830a, 830b, 830c, and 830d are connected to the main power supply 810 through power lines in an existing electrical wiring of a building implementing the present invention. Examples of the plurality of electrical appliances 830a, 830b, 830c, and 830d include but are not limited to a refrigerator, an air conditioner, a television, a water heater, a microwave oven, a coffee maker, a lighting device, an electric fan, a computer, a washing machine, a food processor and an induction stove.

A SLIC-P module among the plurality of SLIC-P modules 825a, and 825b, is embedded in a detachable power cord of an electrical appliance among the plurality of electrical appliances 830a, 830b, 830c and 830d. The plurality of SLIC-P modules 825a, and 825b, is in communication with the central unit 815 through the power lines using a power line communication protocol. Examples of the power line communication protocols include any of the known or proprietary power line communication protocols including PLC-BUS communication protocol, X-10 protocol, CE Bus protocol, and Home plug 1.0 protocol. In some embodiments, the protocol used can be other than power line protocols, such as zigbee, Wifi, Bluetooth etc. The SLIC-P module is enabled to switch ON and switch OFF the electrical appliance by blocking current flowing through the power cord of the electrical appliance. Further, in the present invention, an SLIC-C module is installed in an electrical appliance among the plurality of electrical appliances 830a, 830b, 830c and 830d. The SLIC-C module is enabled to transfer data to the electrical appliance and from the electrical appliance. Further, the SLIC-C module is enabled to monitor and control the internal settings of the electrical appliance.

A user is enabled to input instructions pertaining to controlling electrical appliances among the plurality of electrical appliances 830a, 830b, 830c, and 830d, to the central unit 815. The central unit 815, the plurality of sockets 820a, 820b and 820c, the plurality of SLIC-P modules 825a, and 825b, and the plurality of smart control modules 835a and 835b provide the necessary control over switching ON and switching OFF of the plurality of electrical appliances 830a, 830b, 830c, and 830d. In one embodiment, the plurality of SLIC-P modules 825a and 825b, and the plurality of smart control modules 835a and 835b are capable of wireless communication. In such a case, the user is enabled to input instructions pertaining to controlling the electrical appliances via one of a wireless network and the central unit 815.

A first electrical appliance 830a among the plurality of electrical appliances 830a, 830b, 830c, and 830d, is connected to the main power supply 810 via a first SLIC-P module 825a and a first socket 820a. The first SLIC-P module 825a is embedded in a first detachable power cord of the first electrical appliance 830a. The first SLIC-P module 825a communicates with the central unit 815 via the power lines. The first SLIC-P module 825a is enabled to control switching ON and switching OFF states of the first electrical appliance 830a.

A second electrical appliance 830b among the plurality of electrical appliances 830a, 830b, 830c and 830d, is connected to the main power supply 810 via a second SLIC-P module 825b and the first socket 820a. A SLIC-C module 840 is installed on a socket side of the second electrical appliance 830b. The second SLIC-P module 825b communicates with the central unit 815 via the electrical wiring in the buildings and provides control over switching ON and switching OFF the second electrical appliance 830b. The second SLIC-P module 825b is embedded in a second detachable power cord of the second electrical appliance 830b. The SLIC-C module 840 communicates with the central unit 815 and enables transfer of data with the second electrical appliance 830b. Further, the SLIC-C module 840 enables monitoring and controlling of internal settings of the second electrical appliance 830b.

A third electrical appliance 830c among the plurality of electrical appliances 830a, 830b, 830c and 830d, is connected to the main power supply 810 via a second socket 820b. A first smart control module 835a is installed in the third electrical appliance 830c. The first smart control module 835a of the second socket 820b communicates with the central unit 815 via the electrical wiring in the buildings. The first smart control module 835a is enabled to control switching ON and switching OFF states of the third electrical appliance 830c. Further, the first smart control module 835a is enabled to monitor and control internal settings of the third electrical appliance 830c and to transfer data with the third electrical appliance 830c.

A fourth electrical appliance 830d among the plurality of electrical appliances 830a, 830b, 830c and 830d, is connected to the main power supply 810 via a third socket 820c. A second smart control module 835b is installed in a third detachable power cord of the fourth electrical appliance 830d. The second smart control module 835b of the third socket 820c communicates with the central unit 815 via the power lines. The second smart control module 835b is enabled to control switching ON and switching OFF of the fourth electrical appliance 830d. Further, the second smart control module 835b is enabled to monitor and control internal settings of the fourth electrical appliance 830d and to transfer data with the fourth electrical appliance 830d.

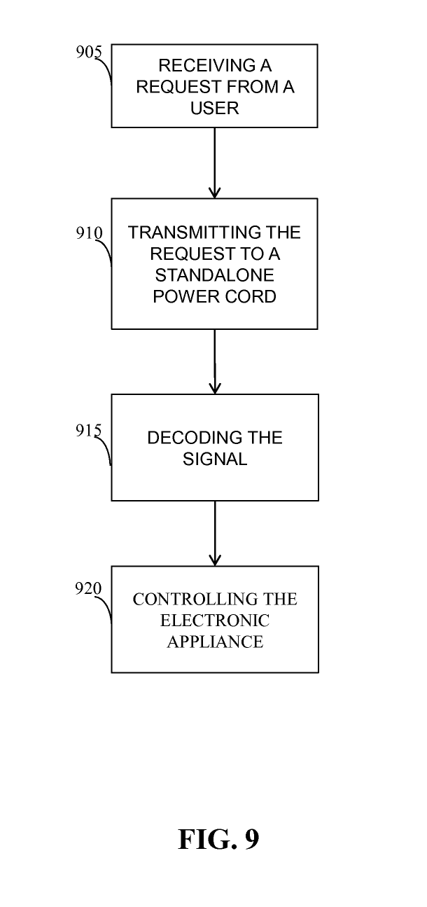

FIG. 9 is a flowchart illustrating a method of controlling an electrical appliance, in accordance with one embodiments of the present invention. The electrical appliance includes one of a refrigerator, an air conditioner, a television, a water heater, a microwave oven, a coffee maker, a lighting device, and a fan.

At step 905, a request is received from a user of the electrical appliance. The user initiates the request via one of a user interface and a remote control. The request is received by a central unit to control the electrical appliance. The central unit encodes the request to generate a signal.

At step 910, the request is transmitted as a signal to a standalone power cord. The signal is transmitted via the electrical wiring in the buildings connected to the power supply. The signal includes at least one of a data signal and a control signal.

At step 915, the standalone power cord decodes the data and control signals from the signals. The standalone power cord fetches the signals through a first electrical connected attached to a power socket in the electrical wiring in the building. The standalone module includes a smart control module for automating the electrical appliance. The smart control module decodes the signal. Further, the smart control module identifies type of request.

At step 920, the electrical appliance is controlled by the standalone power cord. The electrical appliance is controlled based on the request. The standalone power cord switch ON and switch OFF the electrical appliance, based on the control signal decoded by smart control module. Further, the standalone power cord regulate the electrical appliance to fine-control the electrical appliance based on the data signal decoded by the smart control module.

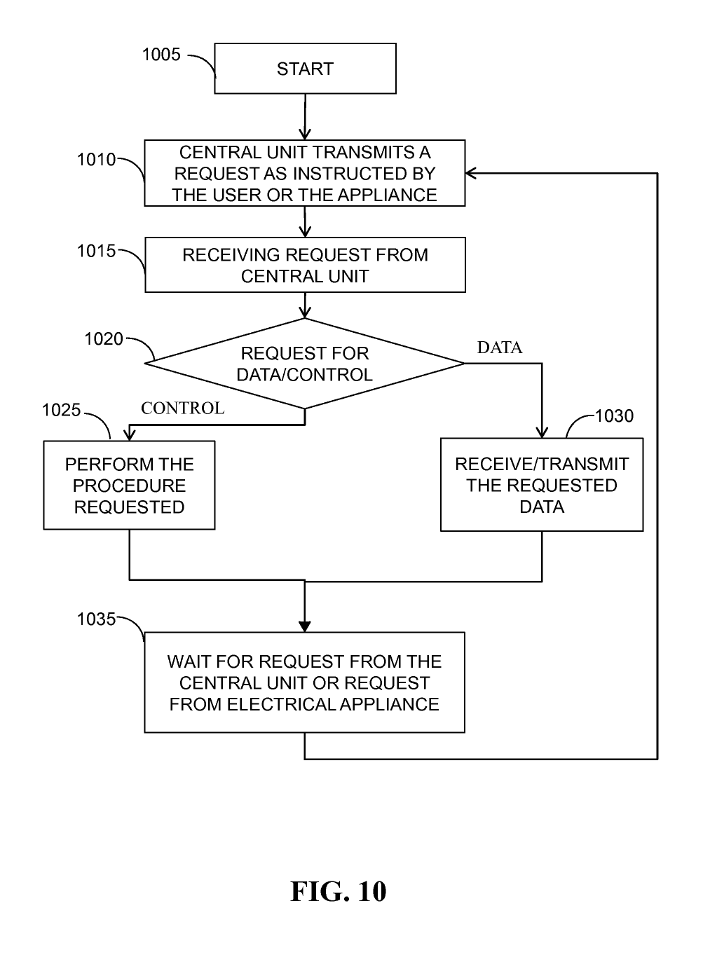

FIG. 10 is a flowchart illustrating steps to control an electrical appliance.

The flowchart begins at step 1005.

At step 1010, a central unit transmits a request to the module. The request depends on an instruction given by one of the user and the electrical appliance. The user inputs the instruction to the central unit via an input terminal of the central unit. The electrical appliance transmits the instruction to the central unit through power line communication. The request is transmitted to the module via power lines in a building where the present invention is implemented. The request is one of a control request and a data request or a combination thereof.

At step 1015, the module receives the request from the central unit. The request is processed by a microprocessor in the module. The module contains an SLIC-P module integrated with an SLIC-C module.

At step 1020, the module checks whether the request from the central unit is the data request or the control request. If the request is the control request, step 1025 is performed else if the request is the data request, step 1030 is performed.

At step 1025, a control request is performed on the electrical appliance. The control request is one of a switching ON request, a switching OFF request, and a request to update internal settings of the electrical appliance.

At step 1030, a data requested in the data request is acquired by the module from the electrical appliance and is transmitted to the central unit. An exposed data interface on the module facilitates finer control and data communication between the electrical appliance and the central unit thereby enhancing the existing electrical appliance to a smart device. In another embodiment, the data is received by the electrical appliance from the central unit.

At step 1035, the module waits for another request from one of the central unit and the electrical appliance.

At the reception of a request, step 1010 is performed and the whole process repeats.

Advantageously, the embodiments in the present disclosure, a module to aid in implementing a home automation system in a building without having the need for upgrading switches and power sockets installed in an existing electrical wiring of the building is disclosed. The present invention is not limited to home appliances but is used wherever electrical appliance/outlet is desired to be controlled or monitored. The present invention eliminates the need for expensive wireless networks in home automation systems. Further, the present invention eliminates the need for providing add-ons and plug-ins in the home automation systems. Further, the present invention reduces the net infrastructure required to implement the home automation system, thereby reducing the cost involved in implementing the home automation system. Further, the present invention provides adaptability and penetration of home automation systems into a wide range of electrical appliances. Moreover, the present invention is implemented in power cords of electrical appliances thereby enabling the implementation of the home automation systems without major overhaul of the design of the electrical appliances by the appliance manufacturers.

In the preceding specification, the present disclosure and its advantages have been described with reference to specific embodiments. However, it will be apparent to a person of ordinary skill in the art that various modifications and changes can be made, without departing from the scope of the present disclosure.

Accordingly, the specification and figures are to be regarded as illustrative examples of the present disclosure, rather than in restrictive sense. All such possible modifications are intended to be included within the scope of the present disclosure.

What is claimed is:

1. A standalone power cord to control an electrical appliance, the standalone power cord comprising:
a first electrical connector at one end of the standalone power cord, wherein the first electrical connector connects the standalone power cord to a power source;
a second electrical connector at other end of the standalone power cord, wherein the second electrical connector connects the standalone power cord to the electrical appliance; and
a smart control module to control the electrical appliance, wherein the smart control module comprises:
a Smart Link Interface Compliant-Power cable (SLIC-P) module to enable switching ON and switching OFF the electrical appliance; and
a Smart Link Interface Compliant-Socket (SLIC-C) module to fine-control one or more parameters of the electrical appliance.

2. The standalone power cord as claimed in claim 1, wherein the second electrical connector comprises:
a power terminal to supply power to the electrical appliance; and
a signal terminal, wherein the signal terminal comprises one or more of:
a data signal terminal to communicate data instructions,
a control signal terminal to communicate control instructions, and
a combination thereof.

3. The standalone power cord as claimed in claim 1, wherein the second electrical connector comprises a signal isolation transceiver.

4. The standalone power cord as claimed in claim 1, wherein the smart control module is programmable to receive instructions from a central unit.

5. The standalone power cord as claimed in claim 1, wherein the SLIC-P module comprises:
a signal decoder to decode data and control instructions from a signal;
a relay switch to provide a path for current flow between the first electrical connector and the second electrical connector; and
a microprocessor to enable switching ON and switching OFF the relay switch.

6. The standalone power cord as claimed in claim 1, wherein the SLIC-C module comprises:
a data acquisition module to acquire data from the electronic appliance; and
a monitor and control module to fine-control the electrical appliance, wherein the monitor and control module:
monitor internal settings of the electrical appliance; and
control at least one of a plurality of parameters of the electrical appliance by changing the internal setting, thereby achieving fine-control of the electrical appliance.

7. The standalone power cord as claimed in claim 1, wherein the electrical appliance is one of, but not limited to a refrigerator, an air conditioner, a television, a water heater, a microwave oven, a coffee maker, a lighting device, and a fan.

8. The standalone power cord as claimed in claim 1, wherein the one or more parameters of electrical appliance includes temperature, speed, brightness, and volume.

9. A method of controlling an electrical appliance, the method comprising:
receiving a request from a user input device, wherein the request is received by a central unit to control the electrical appliance;
transmitting the request as a signal by the central unit to a standalone power cord, wherein signal comprises at least one of a data signal and a control signal;
decoding the signal by the standalone power cord; and
controlling the electrical appliance based on the request, wherein the controlling is performed by the standalone power cord.

10. The method as claimed in claim 9, wherein the user input device includes but is not limited to remote control, touch pad, gesture control, voice control, and touch ball.

11. The method as claimed in claim 9, wherein the request is transmitted via at least one of power lines and electrical wirings.

12. The method as claimed in claim 9, wherein the electrical appliance is one of a refrigerator, an air conditioner, a television, a water heater, a microwave oven, a coffee maker, a lighting device, and a fan.

13. The method as claimed in claim 9, wherein decoding the signal comprises:
transmitting the signal to a signal decoder, wherein the request is transmitted by the central unit; and
decoding instructions from the signal, wherein the instructions include data and control instructions.

14. The method as claimed in claim 9, wherein controlling the electrical appliance based on the request further comprises:
acquiring data from the electrical appliances;
monitoring internal settings of the electrical appliances; and
controlling at least one of a plurality of parameters of the electrical appliances by varying the internal settings of the electrical appliance.

15. The method as claimed in claim 14, wherein the controlling comprises at least one of:
switching ON and switching OFF the electrical appliance; and
regulating the electrical appliance to fine-control the electrical appliance.

16. The method as claimed in claim 14, wherein parameters of the electrical appliance include but are not limited to temperature, speed, brightness and volume.
